(19) United States
(12) Patent Application Publication
(10) Pub. No.: US 2026/0222618 A1
(43) Pub. Date: Jul. 30, 2026

(54) VIDEO CODING METHOD OF APPLYING BIT DEPTH REDUCTION TO CROSS-COMPONENT PREDICTION PARAMETERS BEFORE STORING CROSS-COMPONENT PREDICTION PARAMETERS INTO BUFFER AND ASSOCIATED APPARATUS

(71) Applicant: MEDIATEK INC., Hsin-Chu (TW)

(72) Inventors: Cheng-Yen Chuang, Hsinchu City (TW); Hsin-Yi Tseng, Hsinchu City (TW); Chia-Ming Tsai, Hsinchu City (TW); Chih-Wei Hsu, Hsinchu City (TW); Yi-Wen Chen, San Jose, CA (US); Ching-Yeh Chen, Hsinchu City (TW); Tzu-Der Chuang, Hsinchu City (TW); Man-Shu Chiang, Hsinchu City (TW)

(73) Assignee: MEDIATEK INC., Hsin-Chu (TW)

(21) Appl. No.: 19/146,934

(22) PCT Filed: Jan. 11, 2024
(86) PCT No.: PCT/CN2024/071876

§ 371 Date: Jul. 10, 2025

Related U.S. Application Data
(60) Provisional application No. 63/479,744, filed on Jan. 13, 2023.
(60) Provisional application No. 63/479,753, filed on Jan. 13, 2023.

(51) Int. Cl. H04N 19/593; H04N 19/132; H04N 19/159; H04N 19/186; H04N 19/196

(52) U.S. Cl. CPC H04N 19/593; H04N 19/132; H04N 19/159; H04N 19/186; H04N 19/196

(57) ABSTRACT

A method for video coding including: receiving data to be encoded or decoded as a current block of pixels of a current picture of a video, wherein the current block includes at least one chroma block; and encoding or decoding the current block by a cross-component prediction (CCP) mode for intra chroma prediction of the at least one chroma block, which includes: applying bit depth reduction to at least one CCP parameter of a CCP model used by the CCP mode, to generate at least one precision-reduced CCP parameter, and storing a CCM information of the CCP model into a buffer, wherein a bit depth of the at least one precision-reduced CCP parameter is smaller than a bit depth of the at least one CCP parameter, and the CCM information includes the at least one precision-reduced CCP parameter.

### FIELD OF THE INVENTION

The present invention relates to video coding, and more particularly, to a video coding method of applying bit depth reduction to cross-component prediction (CCP) parameters before storing CCP parameters into a buffer and an associated apparatus.

### DESCRIPTION OF THE PRIOR ART

The conventional video coding standards generally adopt a block based coding technique to exploit spatial and temporal redundancy. For example, the basic approach is to divide the whole source picture into a plurality of blocks, perform intra/inter prediction on each block, transform residues of each block, and perform quantization and entropy encoding. Besides, a reconstructed picture is generated in a coding loop to provide reference data used for coding following blocks. For certain video coding standards, in-loop filter(s) may be used for enhancing the image quality of the reconstructed frame.

The video decoder is used to perform an inverse operation of a video encoding operation performed by a video encoder. For example, the video decoder may have a plurality of processing circuits, such as an entropy decoding circuit, an intra prediction circuit, a motion compensation circuit, an inverse quantization circuit, an inverse transform circuit, a reconstruction circuit, and in-loop filter(s).

With the help of cross-component prediction (CCP) models, intra chroma prediction becomes more accurate and the prediction distortion of intra chroma mode could be significantly reduced. The cross-component model (CCM) information (e.g., model parameters, model type, and template region) of previous coded blocks should be stored in a buffer for the use of a CCP merge mode or other similar CCP coding tools. However, for a worst case, each 4×4 block should store one set of CCM information, which can be a huge implementation cost, especially for the part of storing 64-bit CCP model parameters. Thus, there is a need for an innovative buffer requirement reduction design for buffering CCM information of intra chroma blocks coded using the CCP mode.

### SUMMARY OF THE INVENTION

One of the objectives of the claimed invention is to provide a video coding method of applying bit depth reduction to cross-component prediction (CCP) parameters before storing CCP parameters into a buffer and an associated apparatus.

According to a first aspect of the present invention, an exemplary method for video coding is disclosed. The exemplary method includes: receiving data to be encoded or decoded as a current block of pixels of a current picture of a video, wherein the current block comprises at least one chroma block; and encoding or decoding the current block by a cross-component prediction (CCP) mode for intra chroma prediction of the at least one chroma block, comprising: applying bit depth reduction to at least one CCP parameter of a CCP model used by the CCP mode, to generate at least one precision-reduced CCP parameter, wherein a bit depth of the at least one precision-reduced CCP parameter is smaller than a bit depth of the at least one CCP parameter; and storing a cross-component (CCM) information of the CCP model into a buffer, wherein the CCM information comprises the at least one precision-reduced CCP parameter.

According to a second aspect of the present invention, an exemplary video encoder is disclosed. The exemplary video encoder includes a video data memory and an encoding circuit. The video data memory is arranged to receive data to be encoded as a current block of pixels of a current picture of a video, wherein the current block comprises at least one chroma block. The encoding circuit is arranged to perform encoding of the current block by a cross-component prediction (CCP) mode for intra chroma prediction of the at least one chroma block. The encoding circuit includes a buffer and a bit depth adjustment circuit. The bit depth adjustment circuit is arranged to apply bit depth reduction to at least one CCP parameter of a CCP model used by the CCP mode, to generate at least one precision-reduced CCP parameter, and store a cross-component model (CCM) information of the CCP model into the buffer, wherein a bit depth of the at least one precision-reduced CCP parameter is smaller than a bit depth of the at least one CCP parameter, and the CCM information comprises the at least one precision-reduced CCP parameter.

According to a third aspect of the present invention, an exemplary video decoder is disclosed. The exemplary video decoder includes a video data memory and a decoding circuit. The video data memory is arranged to receive data to be decoded as a current block of pixels of a current picture of a video, wherein the current block comprises at least one chroma block. The decoding circuit is arranged to perform decoding of the current block by a cross-component prediction (CCP) mode for intra chroma prediction of the at least one chroma block. The decoding circuit includes a buffer and a bit depth adjustment circuit. The bit depth adjustment circuit is arranged to apply bit depth reduction to at least one CCP parameter of a CCP model used by the CCP mode, to generate at least one precision-reduced CCP parameter, and store a cross-component model (CCM) information of the CCP model into the buffer, wherein a bit depth of the at least one precision-reduced CCP parameter is smaller than a bit depth of the at least one CCP parameter, and the CCM information comprises the at least one precision-reduced CCP parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating multi-type tree splitting modes according to an embodiment of the present invention.

FIG. 2 is a diagram illustrating splitting flags signalling in quadtree with nested multi-type tree coding tree structure according to an embodiment of the present invention.

FIG. 3 is a diagram illustrating an example of quadtree with nested multi-type tree coding block structure according to an embodiment of the present invention.

FIG. 4 is a diagram illustrating examples of disallowed TT and BT partitioning in VTM according to an embodiment of the present invention.

FIG. 5 is a diagram illustrating 67 intra prediction modes according to an embodiment of the present invention.

FIG. 6 is a diagram illustrating reference samples for wide-angular intra prediction according to an embodiment of the present invention.

FIG. 7 is a diagram illustrating locations of the samples used for the derivation of a and β according to an embodiment of the present invention.

FIG. 8 is a diagram illustrating an example of classifying the neighbouring samples into two groups according to an embodiment of the present invention.

FIG. 9 is a diagram illustrating Illustration of the effect of the slope adjustment parameter “u” according to an embodiment of the present invention.

FIG. 10 is a diagram illustrating spatial part of the convolutional filter according to an embodiment of the present invention.

FIG. 11 is a diagram illustrating reference area (with its paddings) used to derive the filter coefficients according to an embodiment of the present invention.

FIG. 12 is a diagram illustrating 16 gradient patterns for GLM according to an embodiment of the present invention.

FIG. 13 is a diagram illustrating positions of spatial merge candidate according to an embodiment of the present invention.

FIG. 14 is a diagram illustrating candidate pairs considered for redundancy check of spatial merge candidates according to an embodiment of the present invention.

FIG. 15 is a diagram illustrating motion vector scaling for temporal merge candidate according to an embodiment of the present invention.

FIG. 16 is a diagram illustrating candidate positions for temporal merge candidate, C₀ and C₁, according to an embodiment of the present invention.

FIG. 17 is a diagram illustrating neighboring blocks used to derive the non-adjacent merge candidates according to an embodiment of the present invention.

FIG. 18 is a diagram illustrating an operation of storing the inter coding or CCM information in CTU-level buffer to picture-level buffer according to an embodiment of the present invention.

FIG. 19 is a block diagram illustrating a video encoder that supports the proposed bit depth reduction design according to an embodiment of the present invention.

FIG. 20 is a diagram illustrating an operation of storing the inter coding and/or CCM information from a current CTU-level buffer to a neighboring CTU-level buffer according to an embodiment of the present invention.

FIG. 21 is a block diagram illustrating a video decoder that supports the proposed bit depth reduction design according to an embodiment of the present invention.

FIG. 22 is a flowchart illustrating a video coding method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

### ACRONYMS

CU: Coding unit
CTB (LCU): Coding tree block (largest coding unit)
HEVC: High Efficiency Video Coding
VVC: Versatile Video Coding
MC: Motion compensation
MV: Motion vector
DF: Deblocking filter
T/IT: Transform/Inverse transform
Q/IQ: Quantization/Inverse quantization
SAO: Sample adaptive offset
ALF: Adaptive loop filter
QTBT: Quad-tree plus binary tree
QT: Quad-tree
BT: Binary-tree
TT: Ternary-tree
SPS: Sequence parameter set
PPS: Picture parameter set
APS: Adaptation Parameter Set
PH: Picture Header
SH: Slice header

### 1. Introduction

### 1.1 Partitioning of the CTUs Using a Tree Structure

In HEVC, a CTU is split into CUs by using a quaternary-tree structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

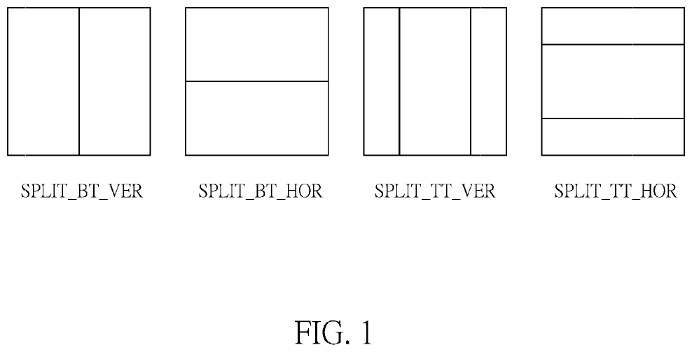

In VVC, a quadtree with nested multi-type tree using binary and ternary splits segmentation structure replaces the concepts of multiple partition unit types, i.e., it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 1, there are four splitting types in multi-type tree structure, vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

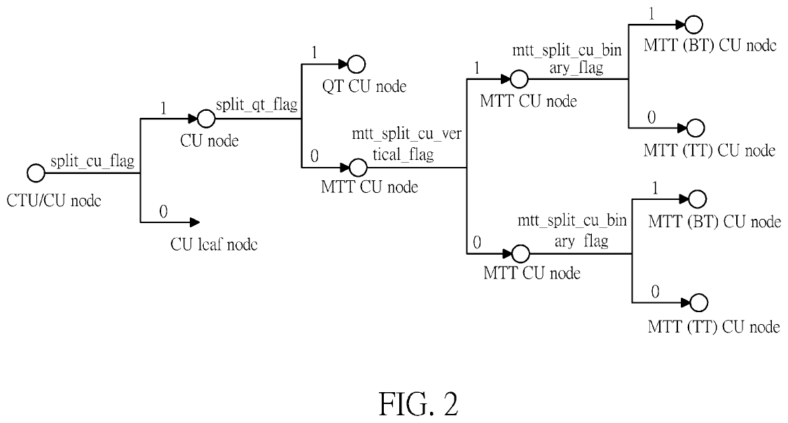

FIG. 2 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it's a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1-1.

TABLE 1-1
MttSplitMode derviation based on multi-type tree syntax elements

| | mtt_split_cu_vertical_{—} | mtt_split_cu_binary_{—} |
|---|---|---|
| MttSplitMode | flag | flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

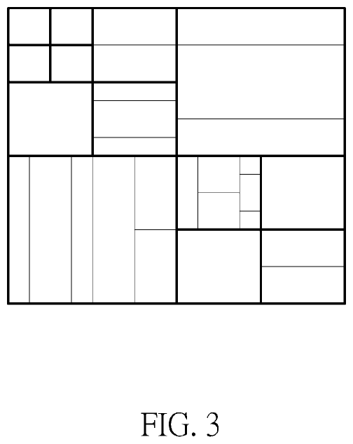

FIG. 3 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### 1.2 Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

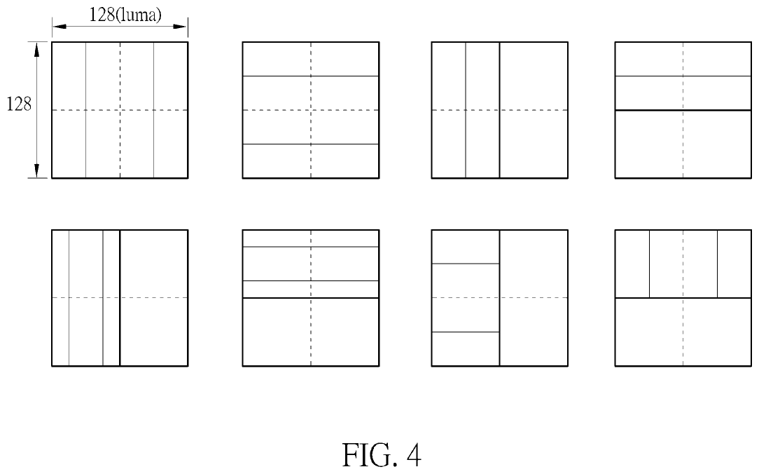

In order to keep the VPDU size as 64×64 luma samples, the following normative partition restrictions (with syntax signaling modification) are applied in VTM, as shown in FIG. 4:
TT split is not allowed for a CU with either width or height, or both width and height equal to 128.
For a 128×N CU with N≤64 (i.e., width equal to 128 and height smaller than 128), horizontal BT is not allowed.
For an N×128 CU with N≤64 (i.e., height equal to 128 and width smaller than 128), vertical BT is not allowed.

### 1.3 Intra Chroma Partitioning and Prediction Restriction

In typical hardware video encoders and decoders, processing throughput drops when a picture has smaller intra blocks because of sample processing data dependency between neighbouring intra blocks. The predictor generation of an intra block requires top and left boundary reconstructed samples from neighbouring blocks. Therefore, intra prediction has to be sequentially processed block by block.

In HEVC, the smallest intra CU is 8×8 luma samples. The luma component of the smallest intra CU can be further split into four 4×4 luma intra prediction units (PUs), but the chroma components of the smallest intra CU cannot be further split. Therefore, the worst case hardware processing throughput occurs when 4×4 chroma intra blocks or 4×4 luma intra blocks are processed. In VVC, in order to improve worst case throughput, chroma intra CBs smaller than 16 chroma samples (size 2×2, 4×2, and 2×4) and chroma intra CBs with width smaller than 4 chroma samples (size 2×N) are disallowed by constraining the partitioning of chroma intra CBs.

In single coding tree, a smallest chroma intra prediction unit (SCIPU) is defined as a coding tree node whose chroma block size is larger than or equal to 16 chroma samples and has at least one child luma block smaller than 64 luma samples, or a coding tree node whose chroma block size is not 2×N and has at least one child luma block 4×N luma samples. It is required that in each SCIPU, all CBs are inter, or all CBs are non-inter, i.e., either intra or intra block copy (IBC). In case of a non-inter SCIPU, it is further required that chroma of the non-inter SCIPU shall not be further split and luma of the SCIPU is allowed to be further split. In this way, the small chroma intra CBs with size less than 16 chroma samples or with size 2×N are removed. In addition, chroma scaling is not applied in case of a non-inter SCIPU. Here, no additional syntax is signalled, and whether a SCIPU is non-inter can be derived by the prediction mode of the first luma CB in the SCIPU. The type of a SCIPU is inferred to be non-inter if the current slice is an I-slice or the current SCIPU has a 4×4 luma partition in it after further split one time (because no inter 4×4 is allowed in VVC); otherwise, the type of the SCIPU (inter or non-inter) is indicated by one flag before parsing the CUs in the SCIPU.

For the dual tree in intra picture, the 2×N intra chroma blocks are removed by disabling vertical binary and vertical ternary splits for 4×N and 8×N chroma partitions, respectively. The small chroma blocks with size 2×2, 4×2, and 2×4 are also removed by partitioning restrictions.

In addition, a restriction on picture size is considered to avoid 2×2/2×4/4×2/2×N intra chroma blocks at the corner of pictures by considering the picture width and height to be multiple of max (8, MinCbSizeY).

1.4 Intra Mode Coding with 67 Intra Prediction Modes

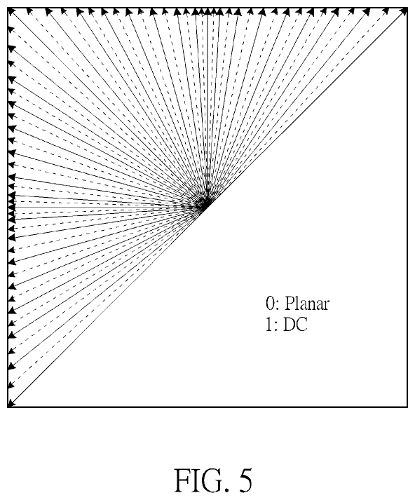

To capture the arbitrary edge directions presented in natural video, the number of directional intra modes in VVC is extended from 33, as used in HEVC, to 65. The new directional modes not in HEVC are depicted as dotted arrows in FIG. 5, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 1.5 Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max−Min is equal to 1:
      MPM list→{Planar, Left, Above, Min−1, Max+1, Min−2}
   Otherwise, if Max−Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1, Min+1, Max−1}
If Left and Above are both angular and they are the same:
   MPM list→{Planar, Left, Left−1, Left+1, Left−2, Left+2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### 1.6 Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

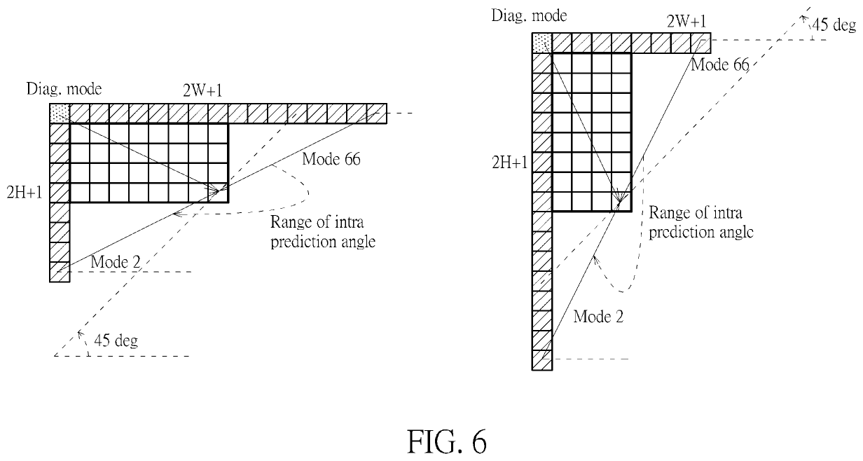

To support these prediction directions, the top reference with length 2W+1, and the left reference with length 2H+1, are defined as shown in FIG. 6.

The number of replaced modes in wide-angular direction mode depends on the aspect ratio of a block. The replaced intra prediction modes are illustrated in Table 1-2.

TABLE 1-2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2 chroma format is updated by replacing some values of the entries of the mapping table to convert prediction angle more precisely for chroma blocks.

### 1.7 Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(I,j) represents the predicted chroma samples in a CU and rec_{L}(I,j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W″ and H′ are set as
W′=W, H′=H when CCLM_LT mode is applied;
   W′=W+H when CCLM_T mode is applied;
H′=H+W when CCLM_L mode is applied;

The above neighbouring positions are denoted as S[0,−1] . . . . S[W′−1,−1] and the left neighbouring positions are denoted as S[−1, 0] . . . . S[−1, H′−1]. Then the four samples are selected as
S[W′/4,−1], S[3*W′/4,−1], S[−1, H′/4], S[−1, 3*H′/4] when CCLM_LT mode is applied and both above and left neighbouring samples are available;
S[W′/8,−1], S[3*W′/8,−1], S[5*W′/8,−1], S[7*W′/8,−1] when CCLM_T mode is applied or only the above neighbouring samples are available;
S[−1, H′/8], S[−1, 3*H′/8], S[−1, 5*H′/8], S[−1, 7*H′/8] when CCLM_L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then Xₐ, X_{b}, Yₐ and Y_{b} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; \qquad ( 2 )$$

$${Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1$$

Finally, the linear model parameters a and B are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

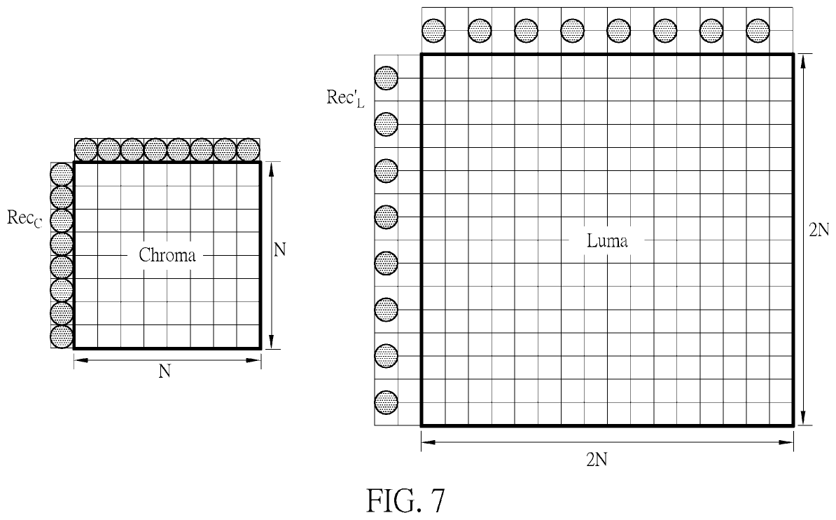

FIG. 7 shows an example of the location of the left and above samples and the sample of the current block involved in the CCLM_LT mode.

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables

Besides the above template and left template can be used to calculate the linear model coefficients together, they also can be used alternatively in the other 2 LM modes, called CCLM_T, and CCLM_L modes.

In CCLM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In CCLM_LT mode, left and above templates are used to calculate the linear model coefficients.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] ≫ 3 \qquad ( 6 )$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3 \qquad ( 7 )$$

Note that only one luma line (general line buffer in intra prediction) is used to make the downsampled luma samples when the upper reference line is at the CTU boundary.

This parameter computation is performed as part of the decoding process, and is not just as an encoder search operation. As a result, no syntax is used to convey the a and β values to the decoder.

For chroma intra mode coding, a total of 8 intra modes are allowed for chroma intra mode coding. Those modes include five traditional intra modes and three cross-component linear model modes (CCLM_LT, CCLM_A, and CCLM_L). Chroma mode signalling and derivation process are shown in Table 1-3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1-3
Derivation of chroma prediction mode from luma
mode when cclm_is enabled

| Chroma | Corresponding luma intra prediction mode | | | | |
|---|---|---|---|---|---|
| prediction | | | | | X |
| mode | 0 | 50 | 18 | 1 | (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 1-4.

TABLE 1-4
Unified binarization table for chroma prediction mode

| Value of intra_chroma_pred_mode | Bin string |
|---|---|
| 4 | 00 |
| 0 | 0100 |
| 1 | 0101 |
| 2 | 0110 |
| 3 | 0111 |
| 5 | 10 |
| 6 | 110 |
| 7 | 111 |

In Table 1-4, the first bin indicates whether it is regular (0) or CCLM modes (1). If it is CCLM mode, then the next bin indicates whether it is CCLM_LT (0) or not. If it is not CCLM_LT, next 1 bin indicates whether it is CCLM_L (0) or CCLM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 1-4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 1.7.1 Multiple Model CCLM

In the JEM, multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples. Three MMLM model modes (MMLM_LT, MMLM_T, and MMLM_L) are allowed for choosing the neighbouring samples from left-side and above-side, above-side only, and left-side only, respectively.

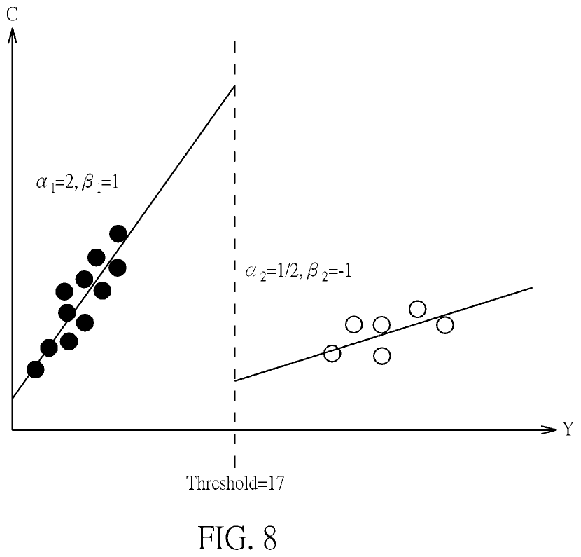

FIG. 8 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} ( x , y ) + {β}_{1} & if {Rec}_{L}^{′} [ x , y ] \leq Threshold \\ {Pred}_{C} [ x , y ] = {α}_{2} \times {Rec}_{L}^{′} ( x , y ) + {β}_{2} & if {Rec}_{L}^{′} [ x , y ] > Threshold\end{matrix} \qquad ( 8 )$$

### 1.7.2 Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$chromaVal = {a}^{′} * lumaVal + {b}^{′}$$

where

$${a}^{′} = a + u$$

$${b}^{′} = b - u * {y}_{r} .$$

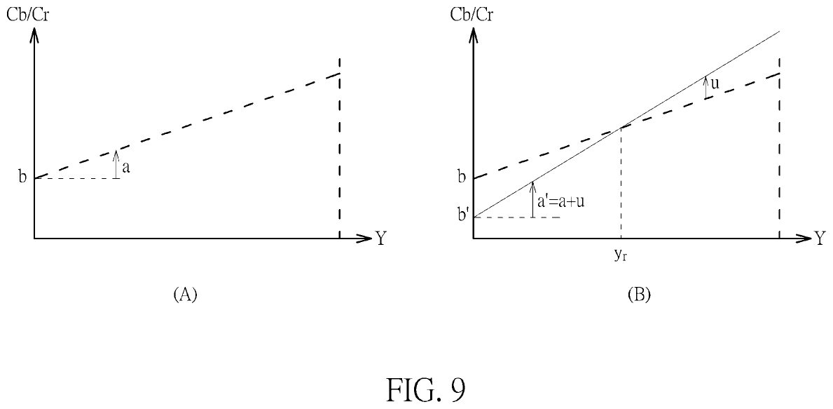

With this selection the mapping function is tilted or rotated around the point with luminance value yᵣ. The average of the reference luma samples used in the model creation as yᵣ in order to provide a meaningful modification to the model. FIG. 9 illustrates the process, where the sub-diagram (A) illustrated a model created with the current CCLM, and the sub-diagram (B) illustrates a model updated as proposed.

### IMPLEMENTATION

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 1.8 Local Illumination Compensation (LIC)

Local Illumination Compensation (LIC) is a method to do inter predict by using neighbor samples of current block and reference block. It is based on a linear model using a scaling factor a and an offset b. It derives a scaling factor a and an offset b by referring to the neighbor samples of current block and reference block. Moreover, it's enabled or disabled adaptively for each CU.

For more detail for LIC, it can refer to the document “JVET-C1001, title: Algorithm Description of Joint Exploration Test Model 3”.

### 1.9 Convolutional Cross-Component Model (CCCM)

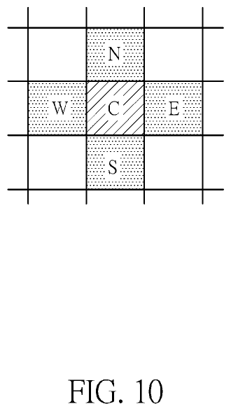

In CCCM, a convolutional model is applied to improve the chroma prediction performance. The convolutional model has 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 10.

The nonlinear term (denoted as P) is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term (denoted as B) represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

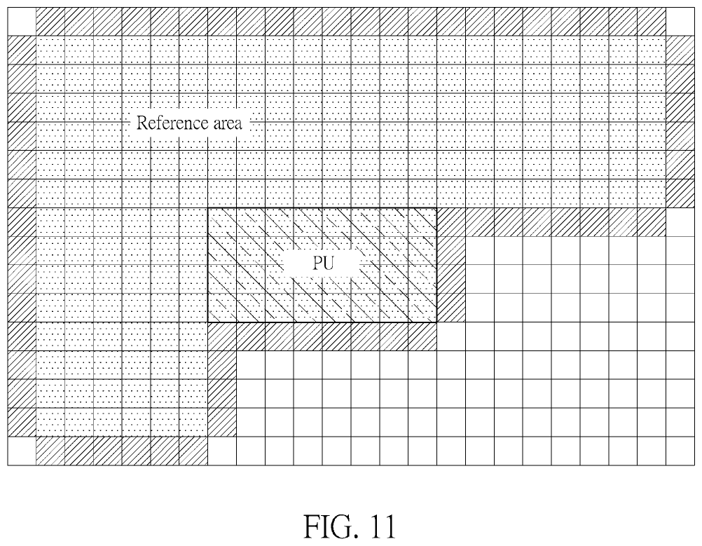

The filter coefficients cᵢ are calculated by minimising MSE between predicted and reconstructed chroma samples in the reference area. FIG. 11 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### 1.10 Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

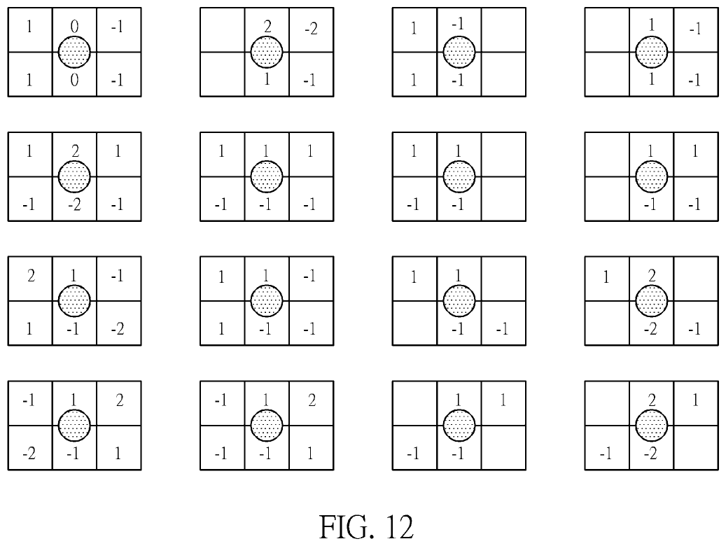

For signaling, when the CCLM mode is enabled to the current CU, two flags are signaled separately for Cb and Cr components to indicate whether GLM is enabled to each component; if the GLM is enabled for one component, one syntax element is further signaled to select one of 16 gradient filters illustrated in FIG. 12 for the gradient calculation. The GLM can be combined with the existing CCLM by signaling one extra flag in bitstream. When such combination is applied, the filter coefficients that are used to derive the input luma samples of the linear model is calculated as the combination of the selected gradient filter of the GLM and the down-sampling filter of the CCLM.

### 1.11 Spatial Candidates Derivation

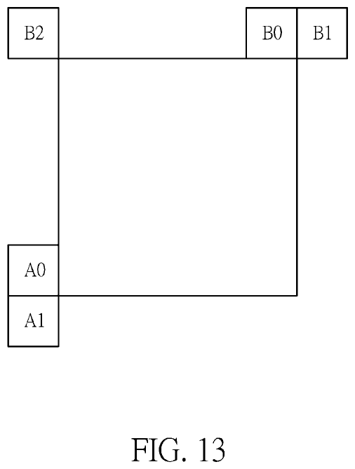

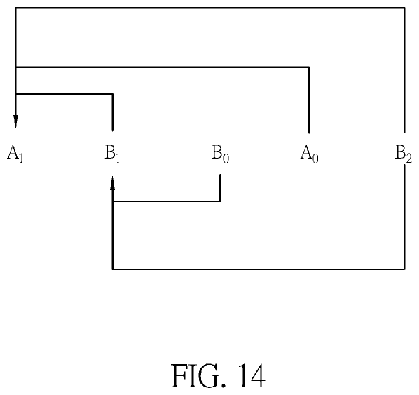

The derivation of spatial merge candidates in VVC is same to that in HEVC except the positions of first two merge candidates are swapped. A maximum of four merge candidates are selected among candidates located in the positions depicted in FIG. 13. The order of derivation is B₀, A₀, B₁, A₁ and B₂. Position B₂ is considered only when one or more than one CUs of position B₀, A₀, B₁, A₁ are not available (e.g., because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 14 are considered and a candidate is only added to the list if the corresponding candidate used for redundancy check has not the same motion information.

### 1.12 Temporal Candidates Derivation

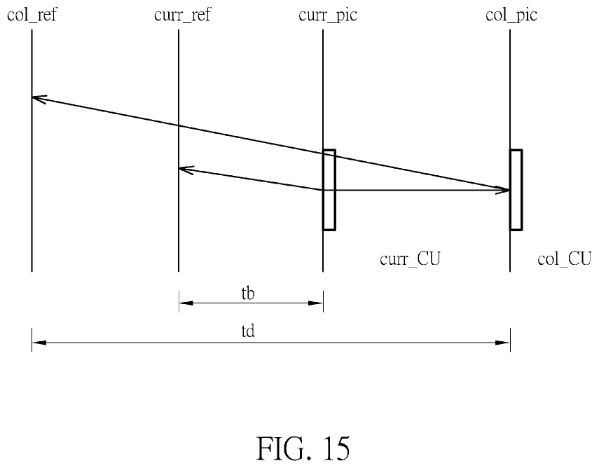

In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signalled in the slice header. The scaled motion vector for temporal merge candidate is obtained as illustrated by the dotted line in FIG. 15, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

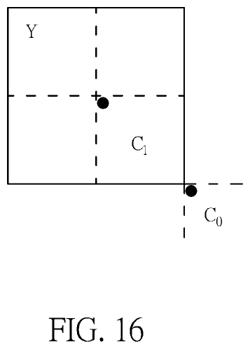

The position for the temporal candidate is selected between candidates C₀ and C₁, as depicted in FIG. 16. If CU at position C₀ is not available, is intra coded, or is outside of the current row of CTUs, position C₁ is used. Otherwise, position C₀ is used in the derivation of the temporal merge candidate.

### 1.13 Non-Adjacent Spatial Candidate

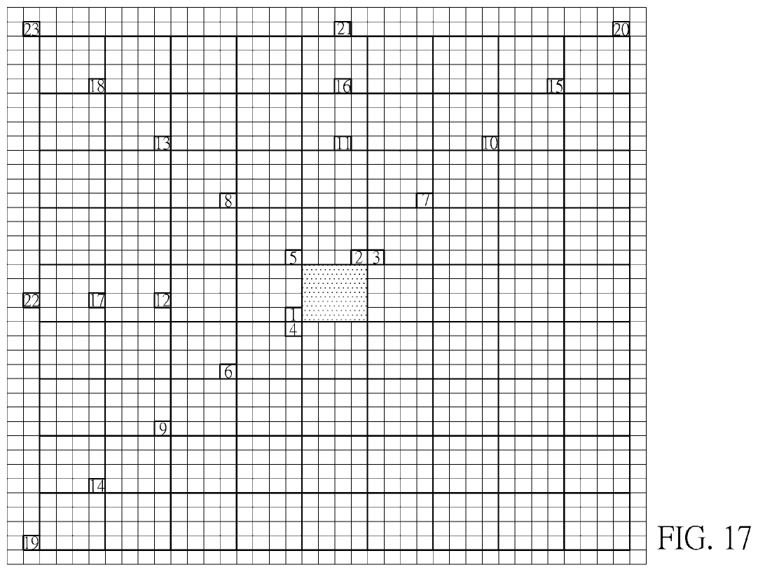

The non-adjacent spatial merge candidates as in JVET-L0399 are inserted after the TMVP in the regular merge candidate list. The pattern of spatial merge candidates is shown in FIG. 17. The distances between non-adjacent spatial candidates and current coding block are based on the width and height of current coding block. The line buffer restriction is not applied.

### 2. Proposed Method

The following methods are proposed to reduce the implementation cost of cross-component prediction merge mode or other similar coding tools:

### 2.1 CCM Parameters Reduction Methods

The CCM related information (e.g., model parameters, model type, template region . . . ) of previous coded blocks should be stored in a buffer for the use of CCP merge mode or other similar coding tools. However, for the worst case, each 4×4 block should store one set of CCP information, which could be a huge implementation cost especially for the part of storing CCP model parameters (e.g., the data type of CCCM parameter is 64-bit integer in ECM implementation). As a result, some bit depth reduction methods for CCP parameters are proposed in this disclosure.

The bit depth reduction method could be applied to the integer part of CCP parameters or the fractional part of CCP parameters.

In one embodiment, a clipping operation could be used in the bit depth reduction method for the integer part of CCP parameters, and there could be one clipping threshold or multiple clipping thresholds. In one embodiment, the clipping threshold could be a pre-defined value, one of multiple pre-defined values in a lookup table or an implicitly derived value.

In one embodiment, the clipping threshold could be the same for all CCP parameters. In another embodiment, the clipping threshold could be all different or partially different for each CCP parameter. In another embodiment, the clipping threshold could be all different or partially different for each parameter type (e.g., spatial term, gradient term, non-linear term, location term or bias term . . . )

In one embodiment, a rounding operation could be used in the bit depth reduction method for the fractional part of CCP parameters. In another embodiment, a round up or round down operation could be used in the bit depth reduction method for the fractional part of CCP parameters.

In one embodiment, the rounding precision could be the same for all CCP parameters. In another embodiment, the rounding precision could be all different or partially different for each CCP parameter. In another embodiment, the rounding precision could be all different or partially different for each parameter type (e.g., spatial term, gradient term, non-linear term, location term or bias term . . . )

In one embodiment, a pruning operation could be used in the bit depth reduction. If the CCP parameter is smaller than a pruning threshold, this parameter will be set to zero. In one embodiment, there could be one pruning threshold or multiple pruning thresholds, and the pruning threshold could be a pre-defined value, one of multiple pre-defined values in a lookup table or an implicitly derived value.

In one embodiment, the pruning threshold could be the same for all CCP parameters. In another embodiment, the pruning threshold could be all different or partially different for each CCP parameter. In another embodiment, the pruning threshold could be all different or partially different for each parameter type (e.g., spatial term, gradient term, non-linear term, location term or bias term).

In one embodiment, some quantization method could be used to reduce the CCP parameter precision.

In one embodiment, the original fixed point CCP parameters could be transformed to floating point datatype, and then further reduce its precision in floating point datatype.

In one embodiment, after the precision reduction, all CCP parameter in one CCP model could have the same bit depth. In another embodiment, after the precision reduction, all CCP parameter in one CCP model could have all different or partially different bit depth.

In one embodiment, the bit depth after precision reduction could depend on the block size. The precision-reduced CCP parameters could have more bit depth if the block size is large. Otherwise, the precision-reduced CCP parameters could have less bit depth if the block size is small.

The CCP information with precision-reduced CCP parameters stored in a buffer could be used in CCP related coding tools. In one embodiment, the spatial candidates of CCP merge mode could inherit the precision-reduced CCP parameters stored in a buffer. In another embodiment, the non-adjacent candidates of CCP merge mode could inherit the precision-reduced CCP parameters stored in a buffer. In another embodiment, the temporal candidates of CCP merge mode could inherit the precision-reduced CCP parameters stored in a buffer. In another embodiment, the CCP information with precision-reduced CCP parameters could be stored in a CCP history list.

### 2.2 Precision Increasement Method of Reduced CCP Parameters

This disclosure also proposes some method to increase the precision of reduced CCP parameter after inheriting or selected by a CCP related coding tool.

The neighboring information could be used to increase the precision of reduced CCP parameter. In one embodiment, the increased precision could be decided by comparing template matching (TM) cost on neighboring template region, and the cost calculation method could be SAD or SATD. In another embodiment, the increased precision could be decided by using boundary matching method.

In one embodiment, the neighboring template region used for precision increasement method could be related to the template type in CCP information. For example, if the CCP mode is CCLM_LT, both top and left template could be used.

In one embodiment, all CCP parameter could apply the precision increasement method. In one embodiment, only some of the CCP parameter could apply the precision increasement method. For example, only the precision of bias term parameter is increased.

2.3 Share Buffer Resource with Existing Coding Tools

To store the cross-component model (CCM) information (e.g., prediction mode, related sub-mode flags, prediction pattern, or model parameters) for further model inheritance, the buffer for storing inter coding information (e.g., motion vector buffer) can be shared to store CCM information. Suppose the minimal allowed block size is m×n, the current CTU size is p×q, and the current picture size is r×s. A CTU-level buffer and picture-level buffers are used for storing the inter coding and CCM information of the current CTU and each picture, respectively. A CTU-level buffer is created for storing the final inter coding or CCM information, and this CTU-level buffer size is ┌p/m┐×┌q/n┐. A picture-level buffer is created for storing the final inter coding or CCM information of the current picture, and this picture-level buffer size is ┌r/i┐×┌s/j┐, where i≥m and j≥n. After encoding or decoding the current block, the inter coding or CCM information of the current block is first saved to the corresponding positions of CTU-level buffer in unit of m×n, where the corresponding positions are the positions covered by the current block in unit of m×n. Later, after encoding or decoding the current CTU, the inter coding or CCM information in the current CTU-level buffer are saved to the corresponding positions of the picture-level buffer in unit of i×j.

In one embodiment, if the unit of CTU-level buffer and picture-level buffer are not the same (e.g., i>m or j>n), the inter coding information or the CCM information in CTU-level buffer should be sub-sampled before being saved to the picture-level buffer. Suppose

$$\frac{i}{m} = g and \frac{j}{n} = h ,$$

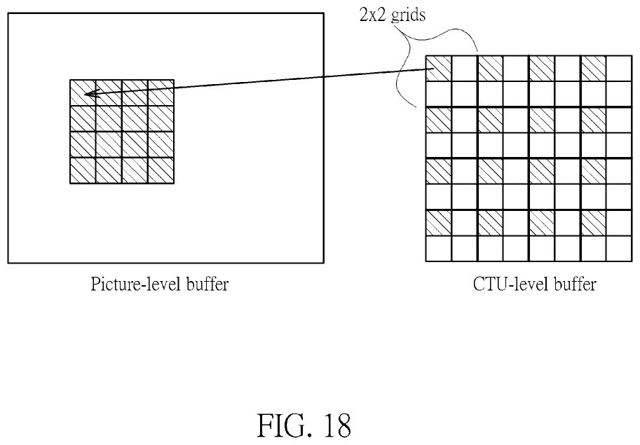

for each g×h grid, one unit out of the g×h grid of the CTU-level buffer is selected, the inter coding information or the CCM information of that unit is saved to the corresponding position of the picture-level buffer. For example, as shown in FIG. 18, if g=2 and h=2, one selected position of each 2×2 grid is selected, the inter coding information or the CCM information is saved to the corresponding position of the picture-level buffer. In one embodiment, the selected position could be the left-above, left-bottom, right-above, or right-bottom of each 2×2 grid. As shown in FIG. 18, the inter coding information or the CCM information at the left-above position marked in slash of each 2×2 grid is saved to the picture-level buffer. In another embodiment, when subsampling the CCM information in CTU-level buffer for saving to the picture-level buffer, it could conditionally check the prediction modes inside the g×h grids. For example, if more than a percentage of positions inside the g×h grids are intra mode (e.g., more than 50% or 75%), the selected and saved data is CCM information. Otherwise (i.e., most of positions inside the g×h grids are inter mode), the selected and saved data is inter coding information. When selecting the candidate for saving to picture-level buffer, it could follow a predefined scanning order to select the first allowed candidate. For example, if the selected and saved data is CCM information, it could select the first grid inside the g×h grids that has CCM information by a predefined scanning order. For another example, if the selected and saved data is inter coding information, it could select the first grid inside the g×h grids that has inter coding information by a predefined scanning order.

In one embodiment, to store the cross-component model (CCM) information (e.g., prediction mode, related sub-mode flags, prediction pattern, or model parameters) for further model inheritance, the buffer for storing inter coding information (e.g., motion vector buffer) can be shared to store CCM information. Suppose the minimal allowed block size is m×n, the current CTU size is p×q. A CTU-level buffer is used for storing the inter coding information and CCM information of current CTU. And multiple CTU-level buffers are used for storing the inter-coding information and CCM information of neighboring CTUs. The current CTU-level buffer is created for storing the final inter coding or CCM information, and the current CTU-level buffer size is ┌p/m┐×┌q/n┐. The neighboring CTU-level buffers are created for storing the final inter coding or CCM information of neighboring CTUs, and this CTU-level buffer size is ┌p/i┐×┌q/j┐, where i≥m and j≥n. The inter coding or CCM information of the current block is firstly saved to the corresponding positions of the current CTU-level buffer in unit of m×n, where the corresponding positions are the positions covered by the current block in unit of m×n. Later, after encoding or decoding the current CTU, the inter coding or CCM information in the current CTU-level buffer are saved to the corresponding positions of the neighboring CTU-level buffer in unit of i×j

In one embodiment, if the unit of the destination buffer is not the same as the source buffer (i.e., i>m or j>n, and hence the destination buffer is smaller than the source buffer), the inter coding information or the CCM information in the source buffer should be sub-sampled before being saved to the destination buffer. The source and destination buffer could be the current CTU-level buffer and the picture-level buffer respectively. Or the source and destination buffer could be the current CTU-level buffer and the neighboring CTU-level buffers.

In one embodiment, in order to store the CCM information and the inter coding information in the same buffer, the precision of the CCM information parameters could be reduced according to the methods mentioned in Sec. 2.1 so the memory size needed for storing one set of CCM information is the same as the memory sized needed for storing one set of the inter coding information.

In another embodiment, the level of CCM information precision reduction could depends on the size of the current block. For example, assume to store a set of inter-coding information, memory size k is needed. If the size of current block is 2m×2n, the allowed memory size to store CCM information of current block is 4k. The precision of the CCM information parameters could be reduced according to the methods mentioned in Sec. 2.1 so the memory size needed for storing one set of CCM information is 4k. For example, assume to store a set of inter-coding information, memory size k is needed. If the size of current block is m×n, the allowed memory size to store CCM information of current block is k. The precision of the CCM information parameters could be reduced according to the methods mentioned in Sec. 2.1 so the memory size needed for storing one set of CCM information is k.

In another embodiment, the CU prediction mode (e.g., intra prediction, or inter prediction) could be checked to identify if the information stored at a certain buffer position is inter coding or CCM information. In one embodiment, if CU prediction mode is intra prediction, the stored information is CCM information. Otherwise (i.e., CU prediction mode is non-intra prediction), the stored information is inter coding information. In another embodiment, it could set an invalid inter prediction reference index or invalid MV value (e.g., horizontal or vertical MV value) to identify the stored information is CCM information. Otherwise (i.e., valid inter prediction index), the stored information is inter coding information. For example, in VVC standard specification, the inter prediction reference index greater than 2 is invalid, then it could set inter prediction reference index to a value greater than 2 to identify the stored information is CCM information (e.g., inter prediction reference index is 3).

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

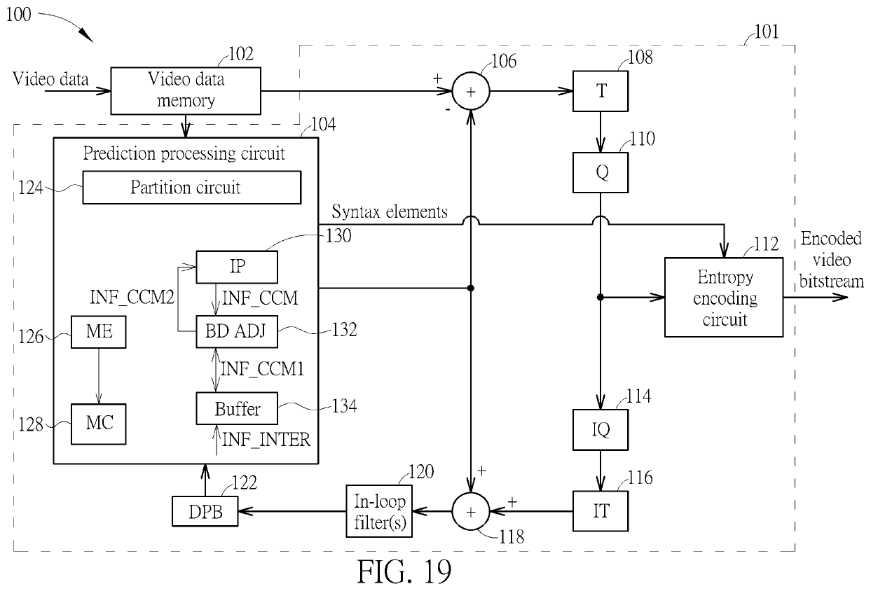

FIG. 19 is a block diagram illustrating a video encoder that supports the proposed bit depth reduction design according to an embodiment of the present invention. By way of example, but not limitation, the video encoder 100 may be a VVC encoder. The video encoder 100 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence.

As shown in FIG. 19, the video encoder 100 includes an encoding circuit 101 and a video data memory 102. The encoding circuit 101 includes a prediction processing circuit 104, a residual generation circuit 106, a transform circuit (labeled by “T”) 108, a quantization circuit (labeled by “Q”) 110, an entropy encoding circuit (e.g., a variable-length code (VLC) encoder) 112, an inverse transform circuit (labeled by “IQ”) 114, an inverse transform circuit (labeled by “IT”) 116, a reconstruction circuit 118, one or more in-loop filters 120, and a decoded picture buffer (DPB) 122. It should be noted that the encoder architecture shown in FIG. 19 is for illustrative purposes only, and is not meant to be a limitation of the present invention. In practice, any video encoder using the proposed bit depth reduction design for reducing the buffer requirement of a cross-component model (CCM) information buffer falls within the scope of the present invention.

The prediction processing circuit 104 may include a partition circuit 124, a motion estimation circuit (labeled by “ME”) 126, a motion compensation circuit (labeled by “MC”) 128, an intra prediction circuit (labeled by “IP”) 130, a bit depth adjustment circuit (labeled by “BD ADJ”) 132, and a buffer 134. In one embodiment, the buffer 134 may act as a CCM information buffer. In another embodiment, the buffer 134 may be a motion vector (MV) information buffer that is shared for buffering the CCM information. Specifically, the video data memory 102 is arranged to receive data to be encoded as a current block of pixels of a current picture of a video, wherein the current block includes at least one chroma block. The encoding circuit 101 is arranged to perform encoding of the current block by a cross-component prediction (CCP) mode for intra chroma prediction of the at least one chroma block. A CCP model is used by the selected CCP mode, and the CCM information may include CCP parameters of the CCP model, a model type of the CCP model, a template region used for determining the CCP parameters of the CCP model, etc. The proposed bit depth reduction design is achieved by the bit depth adjustment circuit 132. The bit depth adjustment circuit 132 is arranged to receive CCM information INF_CCM (which includes at least one CCP parameter of a CCP model) from the CCP mode used by the intra prediction circuit 130, apply bit depth reduction to the at least one CCP parameter of the CCP model used by the CCP mode for intra chroma prediction of the at least one chroma block, to generate at least one precision-reduced CCP parameter, and store CCM information INF_CCM1 of the CCP model into the buffer 134, wherein a bit depth of the at least one precision-reduced CCP parameter is smaller than a bit depth of the at least one CCP parameter, and the CCM information INF_CCM1 includes the at least one precision-reduced CCP parameter generated from the bit depth adjustment circuit 132.

In one embodiment of the present invention, the bit depth adjustment circuit 132 applies the bit depth reduction to an integer part of the at least one CCP parameter, wherein a bit depth of an integer part of the at least one precision-reduced CCP parameter is smaller than a bit depth of the integer part of the at least one CCP parameter. For example, the bit depth adjustment circuit 132 performs a clipping operation upon the integer part (e.g., one or more most significant bits (MSBs) of the integer part) to reduce the bit depth of the integer part of the at least one CCP parameter.

In one embodiment of the present invention, the bit depth adjustment circuit 132 applies the bit depth reduction to a fractional part of the at least one CCP parameter, wherein a bit depth of a fractional part of the at least one precision-reduced CCP parameter is smaller than a bit depth of the fractional part of the at least one CCP parameter. For example, the bit depth adjustment circuit 132 performs a rounding operation upon the fractional part of the at least one CCP parameter after reducing a bit depth of the fractional part of the at least one CCP parameter. That is, the bit depth adjustment circuit 132 removes one or more least significant bits (LSBs) of the fractional part, and then performs the rounding operation upon the last bit of the precision-reduced fractional part.

In one embodiment of the present invention, the bit depth adjustment circuit 132 applies the bit depth reduction to both of the integer part and the fractional part of the at least one CCP parameter.

In one embodiment of the present invention, the bit depth adjustment circuit 132 performs a pruning operation upon the at least one CCP parameter when the at least one CCP parameter is smaller than a pruning threshold. That is, when the at least one CCP parameter has a small non-zero value, the bit depth adjustment circuit 132 achieves bit depth reduction by assigning a zero value to the at least one precision-reduced CCP parameter generated by the pruning operation.

In one embodiment, the bit depth adjustment circuit 132 transforms the at least one CCP parameter from a fixed-point representation to a floating-point representation. Hence, compared to the at least one CCP parameter represented using a fixed-point representation with the use of a large number of bits, the at least one precision-reduced CCP parameter can be represented using a floating-point representation with the use of a small number of bits.

The bit depth of the at least one precision-reduced CCP parameter output from the bit depth adjustment circuit 132 is smaller than the bit depth of the at least one CCP parameter input to the bit depth adjustment circuit 132. In one embodiment, the bit depth after precision reduction may depend on a block size. For example, the bit depth adjustment circuit 132 refers to the block size of the current block to set the bit depth of the at least one precision-reduced CCP parameter. The bit depth of the at least one precision-reduced CCP parameter may be positively proportional to the block size of the current block.

The CCM information INF_CCM1 (which includes the at least one precision-reduced CCP parameter) is stored into the buffer 134. When a next block is being encoded, the CCM information INF_CCM1 becomes CCM information of a previous coded block (i.e., a previous block that is encoded before the current block). It is possible that the CCM information INF_CCM1 in the buffer 134 may be used by a CCP merge mode or other similar CCP mode for intra chroma prediction of another block. In one embodiment, when the CCM information INF_CCM1 (which includes the at least one precision-reduced CCP parameter) is inherited by a CCP related coding tool (e.g., CCP merge mode) selected by encoding of another block, the bit depth adjustment circuit 132 reads the CCM information INF_CCM1 (which includes the at least one precision-reduced CCP parameter) from the buffer 134, applies precision increasement to the at least one precision-reduced CCP parameter to generate at least one precision-increased CCP parameter, and provides the CCM information INF_CCM2 (which includes the at least one precision-increased CCP parameter) to the intra prediction circuit 130, wherein a bit depth of the at least one precision-increased CCP parameter is larger than the bit depth of the at least one precision-reduced CCP parameter.

In one embodiment, the bit depth adjustment circuit 132 decides increased precision of the at least one precision-reduced CCP parameter by template matching. For example, a neighboring template is used to calculate one template matching cost for a precision-reduced CCP parameter with one bit “0” appended to its fractional part and another template matching cost for the precision-reduced CCP parameter with one bit “1” appended to its fractional part, and the precision increasement decides a value of the added bit according to a minimum template matching cost.

In one embodiment, the bit depth adjustment circuit 132 decides increased precision of the at least one precision-reduced CCP parameter by boundary matching. For example, discontinuity measurement between the current block prediction and the neighboring block reconstruction is performed to obtain one boundary matching cost for a precision-reduced CCP parameter with one bit “0” appended to its fractional part and another boundary matching cost for the precision-reduced CCP parameter with one bit “1” appended to its fractional part, and the precision increasement decides a value of the added bit according to a minimum boundary matching cost.

In one embodiment of the present invention, the buffer 134 may act as a dedicated CCM information buffer. Alternatively, the buffer 134 may be a shared buffer that can be used to store information needed by a CCP related coding tool (e.g., CCP merge mode) and an inter-coding tool. For example, one predictive picture (P-picture) may include intra-coded blocks and inter-coded blocks. Hence, as shown in FIG. 19, the buffer 134 is used to store the CCM information INF_CCM1 of an intra-coded block, and is shared with inter-coding information (e.g., MV information) INF_INTER of an inter-coded block.

Since the CCM information INF_CCM1 and the inter-coding information INF INTER of different blocks are stored in the same buffer 134, the bit depth adjustment circuit 132 further applies an upper-bound constraint to a buffer size occupied by the CCM information INF_CCM1. In one embodiment, the bit depth adjustment circuit 132 refers to a buffer size of the inter-coding information INF_INTER to set an upper-bound of a buffer size of the CCM information INF_CCM1. For example, assuming that it takes a buffer size K to store the inter-coding information INF_INTER of one inter-coded block, the buffer size of the CCM information INF_CCM1 of one intra-coded block should be reduced to K. In another embodiment, the bit depth adjustment circuit 132 refers to a block size of the current block to set an upper-bound of a buffer size of the CCM information INF_CCM1. For example, assuming that the minimum allowed size of a block is m×n and the size of the current block is 2m×2n, the buffer size of the CCM information INF_CCM1 of one intra-coded block should be reduced to

$$K \times \frac{2 m \times 2 n}{x \times n} = 4 K .$$

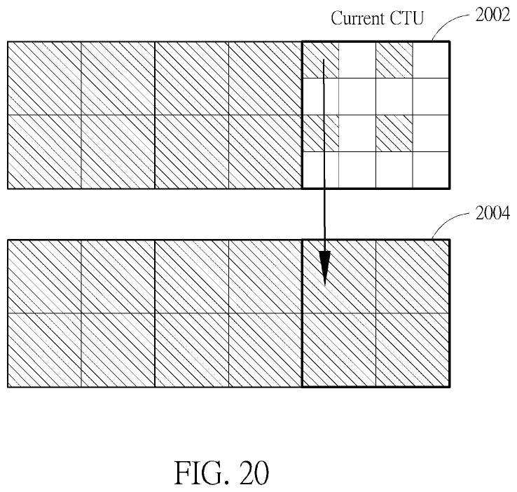

In some embodiments of the present invention, multiple CTU-level buffers may be allocated in the buffer 134, where each CTU-level buffer is used to buffer CCM information and/or inter-coding information of all blocks included in the same CTU. FIG. 20 is a diagram illustrating an operation of storing inter-coding information and/or CCM information from a current CTU-level buffer to a neighboring CTU-level buffer according to an embodiment of the present invention. The CTU-level buffers allocated in the buffer 134 may include one CTU-level buffer 2002 acting as a current CTU-level buffer for buffering CCM information and/or inter-coding information of all blocks included in a current CTU, and another CTU-level buffer 2004 acting as a neighboring CTU-level buffer for buffering CCM information and/or inter-coding information of all blocks included in a previous coded CTU (e.g., a neighboring CTU). For example, the CCM information INF_CCM1 of an intra-coded block and the inter-coding information INF_INTER of an inter-coded block may be stored in the current CTU-level buffer 2002 due to the fact that the intra-coded block and the inter-coded block may belong to the same CTU. In some embodiments of the present invention, the CTU-level buffer 2002 (which acts as a current CTU-level buffer) and CTU-level buffer 2004 (which acts as a neighboring CTU-level buffer) may have different sizes. For example, the CTU-level buffer 2004 (which acts as a neighboring CTU-level buffer) is smaller than the CTU-level buffer 2002 (which acts as a current CTU-level buffer). After encoding of the current CTU is completed, a subset of information stored in the CTU-level buffer 2002 (which acts as a current CTU-level buffer) is selected and then stored into CTU-level buffer 2004 (which acts as a neighboring CTU-level buffer). For example, the subset of information is selected from the CTU-level buffer 2002 (which acts as a current CTU-level buffer) through subsampling the CTU-level buffer 2002 (which acts as a current CTU-level buffer) as predefined positions, as illustrated in FIG. 20.

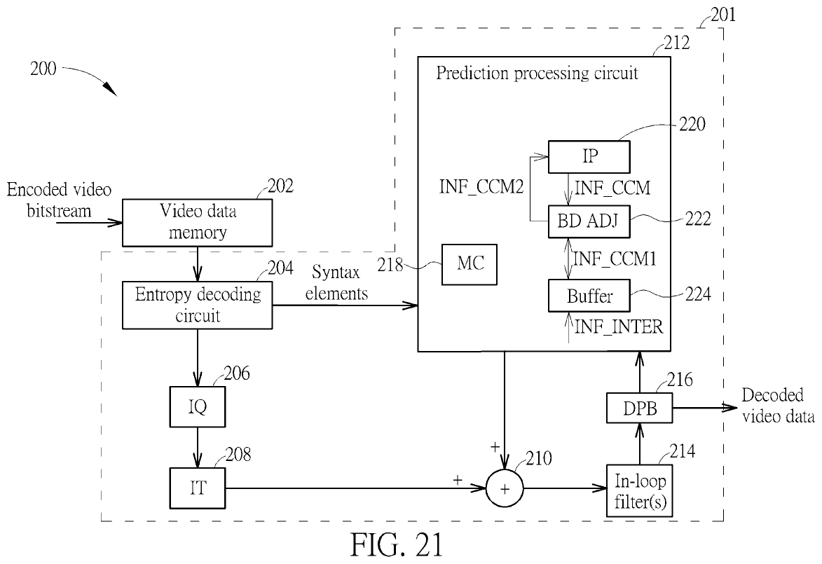

FIG. 21 is a block diagram illustrating a video decoder that supports the proposed bit depth reduction design according to an embodiment of the present invention. By way of example, but not limitation, the video decoder 200 may be a VVC decoder. The video decoder 200 includes a decoding circuit 201 and a video data memory 202. The decoding circuit 201 may include an entropy decoding circuit (e.g., a VLC decoder) 204, an inverse quantization circuit (labeled by “IQ”) 206, an inverse transform circuit (labeled by “IT”) 208, a reconstruction circuit 210, a prediction processing circuit 212, one or more in-loop filters 214, and a decoded picture buffer (DPB) 216. It should be noted that the decoder architecture shown in FIG. 21 is for illustrative purposes only, and is not meant to be a limitation of the present invention. In practice, any video decoder using the proposed bit depth reduction design for reducing the buffer requirement of a CCM information buffer falls within the scope of the present invention.

The prediction processing circuit 212 may include a motion compensation circuit (labeled by “MC”) 218, an intra prediction circuit (labeled by “IP”) 220, a bit depth adjustment circuit (labeled by “BD ADJ”) 222, and a buffer 224. In one embodiment, the buffer 224 may act as a CCM information buffer. In another embodiment, the buffer 224 may be a motion vector (MV) information buffer that is shared for buffering the CCM information. Specifically, the video data memory 202 is arranged to receive data to be decoded as a current block of pixels of a current picture of a video, wherein the current block includes at least one chroma block. The decoding circuit 201 is arranged to perform decoding of the current block by a CCP mode for intra chroma prediction of the at least one chroma block. A CCP model is used by the selected CCP mode, and the CCM information may include CCP parameters of the CCP model, a model type of the CCP model, a template region used for determining the CCP parameters of the CCP model, etc. The proposed bit depth reduction design is achieved by the bit depth adjustment circuit 222. The bit depth adjustment circuit 222 is arranged to receive CCM information INF_CCM (which includes at least one CCP parameter of a CCP model) from the CCP mode used by the intra prediction circuit 220, apply bit depth reduction to the at least one CCP parameter of the CCP model used by the CCP mode for intra chroma prediction of the at least one chroma block, to generate at least one precision-reduced CCP parameter, and store CCM information INF_CCM1 of the CCP model into the buffer 224, wherein a bit depth of the at least one precision-reduced CCP parameter is smaller than a bit depth of the at least one CCP parameter, and the CCM information INF_CCM1 includes the at least one precision-reduced CCP parameter generated from the bit depth adjustment circuit 222.

In one embodiment of the present invention, the bit depth adjustment circuit 222 applies the bit depth reduction to an integer part of the at least one CCP parameter, wherein a bit depth of an integer part of the at least one precision-reduced CCP parameter is smaller than a bit depth of the integer part of the at least one CCP parameter. For example, the bit depth adjustment circuit 222 performs a clipping operation upon the integer part (e.g., one or more most significant bits (MSBs) of the integer part) to reduce the bit depth of the integer part of the at least one CCP parameter.

In one embodiment of the present invention, the bit depth adjustment circuit 222 applies the bit depth reduction to a fractional part of the at least one CCP parameter, wherein a bit depth of a fractional part of the at least one precision-reduced CCP parameter is smaller than a bit depth of the fractional part of the at least one CCP parameter. For example, the bit depth adjustment circuit 222 performs a rounding operation upon the fractional part of the at least one CCP parameter after reducing a bit depth of the fractional part of the at least one CCP parameter. That is, the bit depth adjustment circuit 222 removes one or more least significant bits (LSBs) of the fractional part, and then performs the rounding operation upon the last bit of the precision-reduced fractional part.

In one embodiment of the present invention, the bit depth adjustment circuit 222 applies the bit depth reduction to both of the integer part and the fractional part of the at least one CCP parameter.

In one embodiment of the present invention, the bit depth adjustment circuit 222 performs a pruning operation upon the at least one CCP parameter when the at least one CCP parameter is smaller than a pruning threshold. That is, when the at least one CCP parameter has a small non-zero value, the bit depth adjustment circuit 222 achieves bit depth reduction by assigning a zero value to the at least one precision-reduced CCP parameter generated by the pruning operation.

In one embodiment, the bit depth adjustment circuit 222 transforms the at least one CCP parameter from a fixed-point representation to a floating-point representation. Hence, compared to the at least one CCP parameter represented using a fixed-point representation with the use of a large number of bits, the at least one precision-reduced CCP parameter can be represented using a floating-point representation with the use of a small number of bits.

The bit depth of the at least one precision-reduced CCP parameter output from the bit depth adjustment circuit 222 is smaller than the bit depth of the at least one CCP parameter input to the bit depth adjustment circuit 222. In one embodiment, the bit depth after precision reduction may depend on a block size. For example, the bit depth adjustment circuit 222 refers to the block size of the current block to set the bit depth of the at least one precision-reduced CCP parameter. The bit depth of the at least one precision-reduced CCP parameter may be positively proportional to the block size of the current block.

The CCM information INF_CCM1 (which includes the at least one precision-reduced CCP parameter) is stored into the buffer 224. When a next block is being decoded, the CCM information INF_CCM1 becomes CCM information of a previous coded block (i.e., a block that is decoded before the current block). It is possible that the CCM information INF_CCM1 in the buffer 224 may be used by a CCP merge mode or other similar CCP mode for intra chroma prediction of another block. In one embodiment, when the CCM information INF_CCM1 (which includes the at least one precision-reduced CCP parameter) is inherited by a CCP related coding tool (e.g., CCP merge mode) selected by decoding of another block, the bit depth adjustment circuit 222 reads the CCM information INF_CCM1 (which includes the at least one precision-reduced CCP parameter) from the buffer 224, applies precision increasement to the at least one precision-reduced CCP parameter to generate at least one precision-increased CCP parameter, and provides the CCM information INF_CCM2 (which includes the at least one precision-increased CCP parameter) to the intra prediction circuit 220, wherein a bit depth of the at least one precision-increased CCP parameter is larger than the bit depth of the at least one precision-reduced CCP parameter.

In one embodiment, the bit depth adjustment circuit 222 decides increased precision of the at least one precision-reduced CCP parameter by template matching. For example, a neighboring template is used to calculate one template matching cost for a precision-reduced CCP parameter with one bit “0” appended to its fractional part and another template matching cost for the precision-reduced CCP parameter with one bit “1” appended to its fractional part, and the precision increasement decides a value of the added bit according to a minimum template matching cost.

In one embodiment, the bit depth adjustment circuit 222 decides increased precision of the at least one precision-reduced CCP parameter by boundary matching. For example, discontinuity measurement between the current block prediction and the neighboring block reconstruction is performed to obtain one boundary matching cost for a precision-reduced CCP parameter with one bit “0” appended to its fractional part and another boundary matching cost for the precision-reduced CCP parameter with one bit “1” appended to its fractional part, and the precision increasement decides a value of the added bit according to a minimum boundary matching cost.

In one embodiment of the present invention, the buffer 224 may act as a dedicated CCM information buffer. Alternatively, the buffer 224 may be a shared buffer that can be used to store information needed by a CCP related coding tool (e.g., CCP merge mode) and an inter-coding tool. For example, one predictive picture (P-picture) may include intra-coded blocks and inter-coded blocks. Hence, as shown in FIG. 21, the buffer 224 is used to store the CCM information INF_CCM1 of an intra-coded block, and is shared with inter-coding information (e.g., MV information) INF_INTER of an inter-coded block.

Since the CCM information INF_CCM1 and the inter-coding information INF_INTER of different blocks are stored in the same buffer 224, the bit depth adjustment circuit 222 further applies an upper-bound constraint to a buffer size occupied by the CCM information INF_CCM1. In one embodiment, the bit depth adjustment circuit 222 refers to a buffer size of the inter-coding information INF_INTER to set an upper-bound of a buffer size of the CCM information INF_CCM1. For example, assuming that it takes a buffer size K to store the inter-coding information INF_INTER of one inter-coded block, the buffer size of the CCM information INF_CCM1 of one intra-coded block should be reduced to K. In another embodiment, the bit depth adjustment circuit 222 refers to a block size of the current block to set an upper-bound of a buffer size of the CCM information INF_CCM1. For example, assuming that the minimum allowed size of a block is m×n and the size of the current block is 2m×2n, the buffer size of the CCM information INF_CCM1 of one intra-coded block should be reduced to

$$K \times \frac{2 m \times 2 n}{x \times n} = 4 K .$$

In some embodiments of the present invention, multiple CTU-level buffers may be allocated in the buffer 224, where each CTU-level buffer is used to buffer CCM information and/or inter-coding information of all blocks included in the same CTU. As shown in FIG. 20, the CTU-level buffers allocated in the buffer 224 may include one CTU-level buffer 2002 acting as a current CTU-level buffer for buffering CCM information and/or inter-coding information of all blocks included in a current CTU, and another CTU-level buffer 2004 acting as a neighboring CTU-level buffer for buffering CCM information and/or inter-coding information of all blocks included in a previous coded CTU (e.g., a neighboring CTU). For example, the CCM information INF_CCM1 of an intra-coded block and the inter-coding information INF_INTER of an inter-coded block may be stored in the current CTU-level buffer 2002 due to the fact that the intra-coded block and the inter-coded block may belong to the same CTU. In some embodiments of the present invention, the CTU-level buffer 2002 (which acts as a current CTU-level buffer) and CTU-level buffer 2004 (which acts as a neighboring CTU-level buffer) may have different sizes. For example, the CTU-level buffer 2004 (which acts as a neighboring CTU-level buffer) is smaller than the CTU-level buffer 2002 (which acts as a current CTU-level buffer). After decoding of the current CTU is completed, a subset of information stored in the CTU-level buffer 2002 (which acts as a current CTU-level buffer) is selected and then stored into CTU-level buffer 2004 (which acts as a neighboring CTU-level buffer). For example, the subset of information is selected from the CTU-level buffer 2002 (which acts as a current CTU-level buffer) through subsampling the CTU-level buffer 2002 (which acts as a current CTU-level buffer) as predefined positions, as illustrated in FIG. 20.

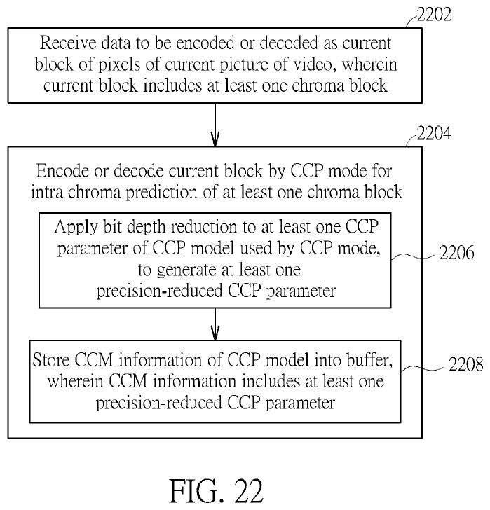

FIG. 22 is a flowchart illustrating a video coding method according to an embodiment of the present invention. The video coding method may be employed by the video encoder 100 shown in FIG. 19 for encoding of video data or the video decoder 200 shown in FIG. 21 for decoding of encoded video bitstream. At step 2202, data to be encoded or decoded is received as a current block of pixels of a current picture of a video, wherein the current block includes at least one chroma block. At step 2004, encoding or decoding of the current block is performed by using a CCP mode for intra chroma prediction of the at least one chroma block. The step 2204 includes sub-steps 2206 and 2208. At sub-step 2206, bit depth reduction is applied to at least one CCP parameter of a CCP model used by the CCP mode, to generate at least one precision-reduced CCP parameter, wherein a bit depth of the at least one precision-reduced CCP parameter is smaller than a bit depth of the at least one CCP parameter. At sub-step 2208, CCM information of the CCP model is stored into a buffer, wherein the CCM information comprises the at least one precision-reduced CCP parameter. As a person skilled in the art can readily understand details of the video coding method after reading above paragraphs with reference to the accompanying drawings, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for video coding, comprising:
receiving data to be encoded or decoded as a current block of pixels of a current picture of a video, wherein the current block comprises at least one chroma block; and
encoding or decoding the current block by a cross-component prediction (CCP) mode for intra chroma prediction of the at least one chroma block, comprising:
applying bit depth reduction to at least one CCP parameter of a CCP model used by the CCP mode, to generate at least one precision-reduced CCP parameter, wherein a bit depth of the at least one precision-reduced CCP parameter is smaller than a bit depth of the at least one CCP parameter; and
storing a cross-component model (CCM) information of the CCP model into a buffer, wherein the CCM information comprises the at least one precision-reduced CCP parameter.

2. The method of claim 1, wherein applying the bit depth reduction to the at least one CCP parameter comprises:
applying the bit depth reduction to an integer part of the at least one CCP parameter, wherein a bit depth of an integer part of the at least one precision-reduced CCP parameter is smaller than a bit depth of the integer part of the at least one CCP parameter.

3. The method of claim 2, wherein applying the bit depth reduction to the integer part of the at least one CCP parameter comprises:
performing a clipping operation upon the integer part to reduce the bit depth of the integer part of the at least one CCP parameter.

4. The method of claim 1, wherein applying the bit depth reduction to the at least one CCP parameter comprises:
applying the bit depth reduction to a fractional part of the at least one CCP parameter, wherein a bit depth of a fractional part of the at least one precision-reduced CCP parameter is smaller than a bit depth of the fractional part of the at least one CCP parameter.

5. The method of claim 4, wherein applying the bit depth reduction to the fractional part of the at least one CCP parameter comprises:
performing a rounding operation upon the fractional part of the at least one CCP parameter after reducing a bit depth of the fractional part of the at least one CCP parameter.

6. The method of claim 1, wherein applying the bit depth reduction to the at least one CCP parameter comprises:
in response to the at least one CCP parameter being smaller than a pruning threshold, performing a pruning operation upon the at least one CCP parameter, wherein the at least one precision-reduced CCP parameter generated by the pruning operation has a zero value.

7. The method of claim 1, wherein applying the bit depth reduction to the at least one CCP parameter comprises:
transforming the at least one CCP parameter from a fixed-point representation to a floating-point representation.

8. The method of claim 1, wherein encoding or decoding the current block by the CCP mode for the intra chroma prediction of the at least one chroma block further comprises:
referring to a block size of the current block to set the bit depth of the at least one precision-reduced CCP parameter.

9. The method of claim 1, further comprising:
in response to the at least one precision-reduced CCP parameter being inherited by a CCP related coding tool selected by encoding or decoding of another block, applying precision increasement to the at least one precision-reduced CCP parameter to generate at least one precision-increased CCP parameter, wherein a bit depth of the at least one precision-increased CCP parameter is larger than the bit depth of the at least one precision-reduced CCP parameter.

10. The method of claim 9, wherein applying the precision increasement to the at least one precision-reduced CCP parameter comprises:
deciding increased precision of the at least one precision-reduced CCP parameter by template matching.

11. The method of claim 9, wherein applying the precision increasement to the at least one precision-reduced CCP parameter comprises:
deciding increased precision of the at least one precision-reduced CCP parameter by boundary matching.

12. The method of claim 1, wherein the buffer is shared with an inter-coding information of an inter-coded block.

13. The method of claim 12, wherein storing the CCM information of the CCP model into the buffer comprises:
referring to a buffer size of the inter-coding information to set an upper-bound of a buffer size of the CCM information.

14. The method of claim 12, wherein storing the CCM information of the CCP model into the buffer comprises:
referring to a block size of the current block to set an upper-bound of a buffer size of the CCM information.

15. The method of claim 12, wherein the current block and the inter-coded block are included in a current coding tree unit (CTU), and the buffer is a current CTU-level buffer.

16. The method of claim 15, further comprising:
after encoding or decoding of the current CTU is completed, selecting a subset of information stored in the current CTU-level buffer, and storing the subset of information into a neighboring CTU-level buffer that is smaller than the current CTU-level buffer.

17. The method of claim 16, wherein the subset of information is selected from the current CTU-level buffer through subsampling the current CTU-level buffer at pre-defined positions.

18. A video encoder, comprising:
a video data memory, arranged to receive data to be encoded as a current block of pixels of a current picture of a video, wherein the current block comprises at least one chroma block; and
an encoding circuit, arranged to perform encoding of the current block by a cross-component prediction (CCP) mode for intra chroma prediction of the at least one chroma block, wherein the encoding circuit comprises:
a buffer; and
a bit depth adjustment circuit, arranged to apply bit depth reduction to at least one CCP parameter of a CCP model used by the CCP mode, to generate at least one precision-reduced CCP parameter, and store a cross-component model (CCM) information of the CCP model into the buffer, wherein a bit depth of the at least one precision-reduced CCP parameter is smaller than a bit depth of the at least one CCP parameter, and the CCM information comprises the at least one precision-reduced CCP parameter.

19. A video decoder, comprising:
a video data memory, arranged to receive data to be decoded as a current block of pixels of a current picture of a video, wherein the current block comprises at least one chroma block; and
a decoding circuit, arranged to perform decoding of the current block by a cross-component prediction (CCP) mode for intra chroma prediction of the at least one chroma block, wherein the decoding circuit comprises:
a buffer; and
a bit depth adjustment circuit, arranged to apply bit depth reduction to at least one CCP parameter of a CCP model used by the CCP mode, to generate at least one precision-reduced CCP parameter, and store a cross-component model (CCM) information of the CCP model into the buffer, wherein a bit depth of the at least one precision-reduced CCP parameter is smaller than a bit depth of the at least one CCP parameter, and the CCM information comprises the at least one precision-reduced CCP parameter.
